(19) United States
(12) Patent Application Publication
(10) Pub. No.: US 2020/0099570 A1
(43) Pub. Date: Mar. 26, 2020

(54) CROSS-DOMAIN TOPOLOGICAL ALARM SUPPRESSION

(71) Applicant: CA, Inc., New York, NY (US)

(72) Inventors: Soumya Subhra Chatterjee, Balurghat (IN); Sandeep Kumar Upadhyay, Jaunpur (IN); Govinda Pichiguntla, Kurnool (IN); Saket Kumar, Ghaziabad (IN); Rajat Bhardwaj, New Dehli (IN)

(21) Appl. No.: 16/142,332

(22) Filed: Sep. 26, 2018

(51) Int. Cl. H04L 12/24

(52) U.S. Cl. CPC H04L 41/06

(57) ABSTRACT

A method of processing alarm messages in a computer network includes receiving an alarm message generated by a node in the computer network and determining whether the alarm message falls within a dependency chain of a previous alarm message. In response to determining that the alarm message falls within the dependency chain of the previous alarm message, the method identifies an alarm group associated with the previous alarm message and determines an affinity of the alarm message to the alarm group. The alarm message is added to the alarm group based on the affinity of the alarm message to the alarm group.

### BACKGROUND

The present disclosure relates to processing of alarm messages in computing systems, and in particular to the processing of alarm messages based on topological relationships.

Computer networks, particularly large, distributed computer networks, are monitored by computer infrastructure monitoring systems that receive and process alarm messages from various network elements. Alarm messages may be presented to computer administrators, who may determine what caused the alarm message and how to address it. In a large computer network, the volume of messages can become large to the point of being intractable, particularly if multiple issues arise in the computer network in a short period of time.

In such instances, it is helpful for the computer administrators to have the alarm messages organized in a manner such that related messages are grouped together so that they can be processed and addressed together, rather than as unrelated incidents. The process of grouping related alarm messages is referred to as “clustering.” Unfortunately, however, it may be difficult to determine which alarm messages are related, as many alarm messages have similar structure and content.

### SUMMARY

Some embodiments provide a method of processing alarm messages in a computer network. The method includes receiving an alarm message generated by a node in the computer network, the alarm message indicating a failure in the computer network, determining whether the alarm message falls within a dependency chain of a previous alarm message, in response to determining that the alarm message falls within the dependency chain of the previous alarm message, identifying an alarm group associated with the previous alarm message and determining an affinity of the alarm message to the alarm group, and adding the alarm message to the alarm group based on the affinity of the alarm message to the alarm group.

The method may further include, in response to determining that the alarm message does not fall within the dependency chain of the previous alarm message, creating a new alarm group and adding the alarm message to the new alarm group as a root cause alarm of the new alarm group.

The alarm group may include a root cause alarm. Determining the affinity of the alarm message to the alarm group may include determining a likelihood that the alarm message was generated as a result of a root failure that caused the root cause alarm to be generated. The method may identify the non-root cause alarms as alarm noise and suppress them, identifying only the root cause alarm message that needs to be further acted upon by an infrastructure management system.

The dependency chain of the previous alarm message may include a group of topologically related nodes in the computer network.

The topologically related nodes may have failure modes associated with the previous alarm message.

Determining the affinity of the alarm message to the alarm group may include determining whether the alarm message was issued within a predetermined time period from when a last alarm in the alarm group was issued.

Determining the affinity of the alarm message to the alarm group may include determining whether the alarm message was issued within a predetermined time period from when the previous alarm message was issued.

The method may further include, after adding the alarm message to the alarm group, determining whether the alarm message falls within the dependency chain of a further alarm message, in response to determining that the alarm message falls within the dependency chain of the further alarm message, identifying a further alarm group associated with the further alarm message and determining an affinity of the alarm message to the further alarm group, and adding the alarm to the further alarm group based on the affinity of the alarm message to the further alarm group.

Determining the affinity of the alarm message to the alarm group may include determining whether an alarm type of the alarm message is causally related to an alarm type of the previous alarm.

Nodes in the computer network may be hierarchically arranged in layers including an application layer, an infrastructure layer, a storage layer and a network layer, and wherein the alarm message was generated by a first node in a first layer of the computer network and the previous alarm message was generated by a second node in a second layer of the computer network that is different than the first layer.

The method may further include generating a cross-layer topology of dependent nodes in the computer network, and identifying failure dependencies between nodes in the computer network across layers.

The previous alarm message may include a root cause alarm from which all other alarm messages in the alarm group depend, and the method may further include resolving the root cause alarm, determining whether a failure that caused the alarm message is resolved as a result of resolution of the root cause alarm, and in response to determining that the failure that caused the alarm message is not resolved as a result of resolution of the root cause alarm, rebuilding a dependency chain associated with the alarm group and identifying a new root cause alarm associated with the alarm group.

An infrastructure monitoring server for a computer network includes a processor circuit, and a memory coupled to the processor circuit. The memory includes computer readable program instructions that cause the processor circuit to receive an alarm message generated by a node in the computer network, the alarm message indicating a failure in the computer network, determine whether the alarm message falls within a dependency chain of a previous alarm message, in response to determining that the alarm message falls within the dependency chain of the previous alarm message, identify an alarm group associated with the previous alarm message and determining an affinity of the alarm message to the alarm group, and add the alarm to the alarm group based on the affinity of the alarm message to the alarm group.

A method of processing alarm messages in a computer network according to further embodiments is provided, wherein nodes in the computer network are hierarchically arranged in layers including an application layer, an infrastructure layer, a storage layer and a network layer. The method includes generating a cross-layer topology of dependent nodes in the computer network, identifying failure dependencies between nodes in the computer network across layers, receiving a plurality of alarm messages, identifying a root cause alarm from among the plurality of alarm messages, wherein the root cause alarm was generated by a first node in a first layer of the computer network, receiving a new alarm message generated by a second node in a second layer of the computer network that is different than the first layer, wherein the new alarm message indicates a failure in the computer network, determining whether the new alarm message falls within a dependency chain of the root cause alarm, in response to determining that the new alarm message falls within the dependency chain of the root cause alarm, identifying an alarm group associated with the root cause alarm and determining an affinity of the new alarm message to the alarm group, and adding the new alarm message to the alarm group based on the affinity of the new alarm message to the alarm group.

Other methods, devices, and computers according to embodiments of the present disclosure will be or become apparent to one with skill in the art upon review of the following drawings and detailed description. It is intended that all such methods, mobile devices, and computers be included within this description, be within the scope of the present inventive subject matter and be protected by the accompanying claims.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram illustrating a network environment in which embodiments according to the inventive concepts can be implemented.

FIG. 2 is a block diagram of an infrastructure monitoring server according to some embodiments of the inventive concepts.

FIG. 3 is a block diagram illustrating a layered network architecture in which an infrastructure monitoring server according to embodiments of the inventive concepts may be deployed.

FIG. 4 illustrates a cross-layer dependency tree of nodes in a layered network architecture according to embodiments of the inventive concepts may be deployed.

FIGS. 5, 6 and 7 are flowcharts illustrating operations of systems/methods in accordance with some embodiments of the inventive concepts.

FIG. 8 is a block diagram of a computing system which can be configured as an infrastructure monitoring server according to some embodiments of the inventive concepts.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

Information Technology (IT) Operation Management tools, such as Infrastructure Monitoring (IM) tools typically operate according to a principle of monitoring everything. While that allows very deep visibility into the entire IT infrastructure, it also means that a large amount of data may be generated in the form of alert messages. The large amount of data generated by an IM tool may be difficult for an operator to process, especially when things go wrong.

Because of the interconnectedness and inter-dependences in an IT infrastructure, a single failure may cause a cascade of failures in downstream systems. For example, a failure of a communication link may cause a resulting failure of a data storage device that uses the communication link.

IM tools, which may monitor different aspects of an IT infrastructure, are often unaware of the existence of each other, and therefore may respond to an event by independently generating alarm messages for each event. The consequence of this is that a flood of alarms may be generated in response to a single failure. These alarm messages, or alarms, may even describe the same “event” but with different reporting times or perspectives.

To address this problem, some IM tools attempt to suppress the “noise” and highlight only those alarm messages that need user action. Often, this is accomplished using a simplistic time-based noise reduction on the assumption that alerts that are in quick succession of each other are most likely correlated. However, that assumption may or may not hold true for all events and thus, following that assumption alone can lead to high error rates in alarm suppression and root cause identification.

Other approaches attempt to filter alarm messages by grouping semantically related alarms using natural language processing techniques. Such approaches have met with mixed success.

Some embodiments described herein provide systems and/or methods for alarm suppression and root cause identification that are not based on natural language analysis of the alarm texts (as that can be misleading due to the issues mentioned above) but use alarm metadata instead. The systems/methods described herein use cross-domain topological analysis to generate with a dependency chain for each possible alerting event, or class of alerting events, that may occur in an IT infrastructure. The dependency chain may be used to determine if there is a cause-and-effect relationship between two alarms, and use that information to suppress alarms that are “effects” and highlight only the “causes.”

Some embodiments described herein utilizes two sets of information that are typically available within a computing system, namely, topological information that describes how devices and applications are related in the infrastructure and a profile that describes “normal” behavior for these devices and applications. For example, alert processing systems, such as CA Digital Operations Intelligence (CA DOI) collect metrices, events, alarms and topologies from different underlying monitoring tools. These monitoring tools individually collect the topologies present at different “layers” of an IT infrastructure (e.g., application, infrastructure, storage, and network layers) and presents that information to the alert processing system, which analyzes the metrics and topology to pre-calculate the data it will need later.

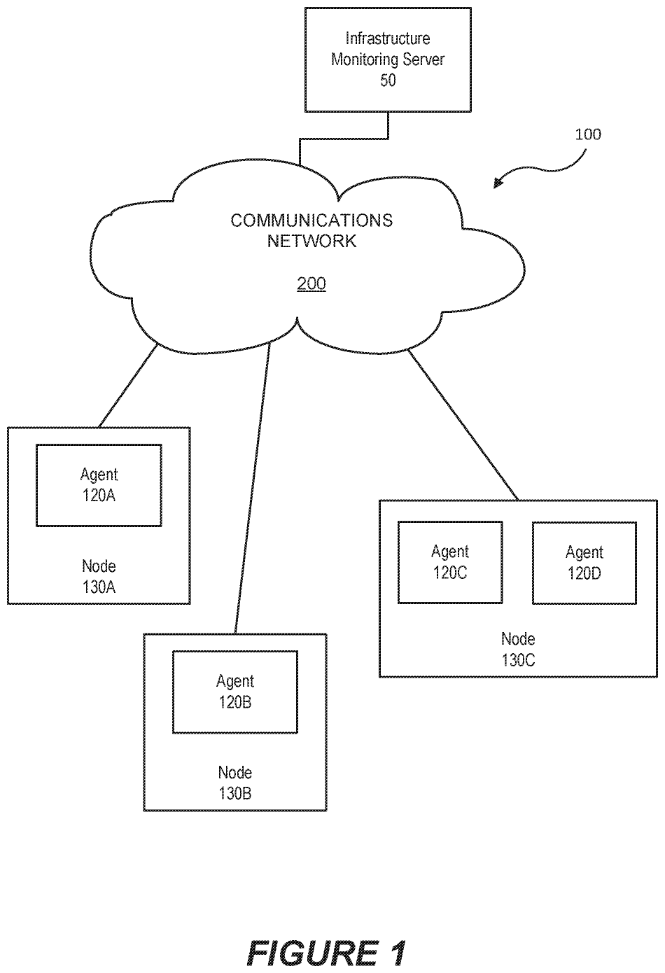

FIG. 1 is a block diagram of an IT infrastructure 100 in which systems/methods according to embodiments of the inventive concepts may be employed. Referring to FIG. 1, a plurality of nodes 130A-130D are provided. The nodes 130A-130D may be generally referred to as nodes 130. The nodes 130 may be physical devices, such as servers that have processors and associated resources, such as memory, storage, communication interfaces, etc., or virtual machines that have virtual resources assigned by a virtual hypervisor. The nodes communicate over a communications network 200, which may be a private network, such as a local area network (LAN) or wide area network (WAN), or a public network, such as the Internet. The communications network 200 may use a communications protocol, such as TCP/IP, in which each network node is assigned a unique network address, or IP address.

One or more of the nodes 130 may host one or more agents 120, which are software applications configured to perform functions in the nodes. In the distributed computing environment illustrated in FIG. 1, messages may be sent to the agents 120, which may process the messages and transmit responses to the messages.

In the distributed computing network illustrated in FIG. 1, each of the nodes 130 in the network may generate and transmit alarm messages to an infrastructure monitoring server 50 in response to events occurring at the network elements. Alarm messages may be generated based on many different types of events, such as data transmission failures or delays, timeouts, and/or capacity, throughput, utilization or other metrics exceeding defined thresholds. When the infrastructure monitoring server 50 receives the alarm messages, it may be helpful to group the messages so that related alarm messages can be dealt with in a coordinated manner.

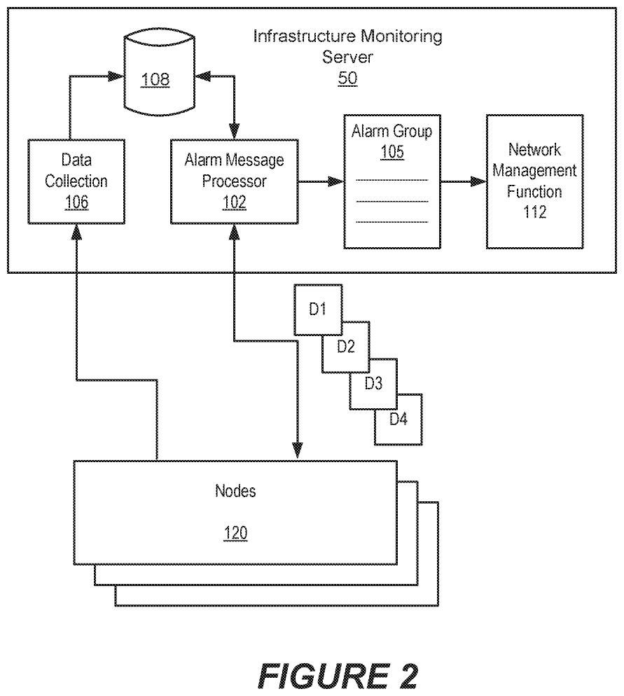

FIG. 2 is a block diagram of an infrastructure monitoring server 50 according to some embodiments showing components of the infrastructure monitoring server 50 in more detail. The infrastructure monitoring server 50 includes various modules that communicate with one another to perform the workload scheduling function. For example, the infrastructure monitoring server 50 includes a data collection module 106, an alarm message processor 102, a database 108, an infrastructure monitoring function 112 and an alarm group 105. It will be appreciated that the infrastructure monitoring server 50 may be implemented on a single physical or virtual machine, or its functionality may be distributed over multiple physical or virtual machines. Moreover, the database 108 may be located in the infrastructure monitoring server 50 or may be accessible to the infrastructure monitoring server 50 over a communication interface. The data collection module 106 may collect data from agents 120 in the distributed computing network, and may store collected data in the database 108. From time to time, the agents 120 may generate alarm messages D1, D2, etc., and transmit the alarm messages to the infrastructure monitoring server 50. Alarm messages typically report error conditions or other conditions that may require intervention by the infrastructure monitoring function 112. Accordingly, alarm messages may be reported to an alarm message processor 102 which receives the alarm messages and collects related alarm messages in an alarm group 105 for handling by an infrastructure monitoring system. The alarm message processor 102 may also store the alarm messages in the database 108 for later use and/or analysis.

As noted above, one problem faced by an infrastructure monitoring function 112 is that a very large number of alarm messages can be generated in a distributed communication network, and it can be very difficult for a network operator to process all of the alarm messages. Accordingly, in such instances, it is helpful for the computer administrators to have the alarm messages organized in a manner that related messages are grouped together so that they can be processed and addressed together, rather than as unrelated incidents, in a process known as clustering.

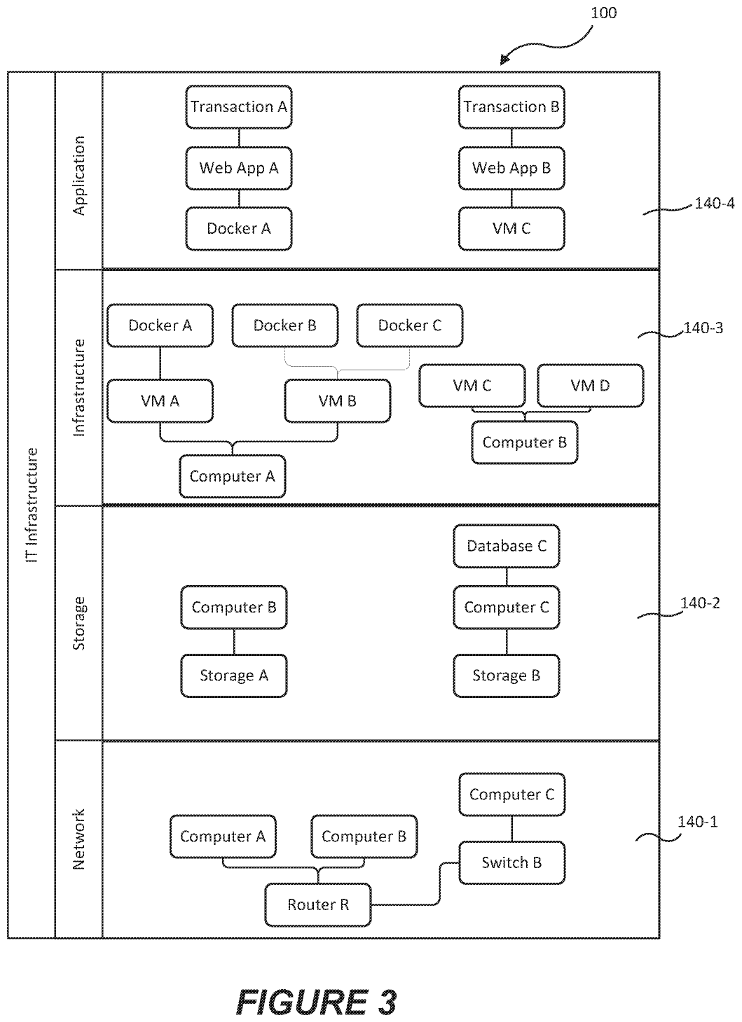

FIG. 3 illustrates an IT infrastructure 100 as viewed by topological layers, namely, a network layer 140-1, a storage layer 140-2, an infrastructure layer 140-3, and an application layer 140-4. The network layer 140-1 includes elements such as routers, switches, computers, etc. The storage layer 140-2 includes elements such as hard drives, servers, etc. The infrastructure layer 140-3 includes elements such as computers, virtual machines (VMs), docker containers, etc. The application layer 140-4 includes elements such as applications (desktop, server, mobile web apps etc.), transactions, etc. Note that it is possible for one element to appear in multiple layers. Connections between the elements denote a functional or logical relationship between the two elements. For example, in the network layer of the system illustrated in FIG. 3, two computers, Computer A and Computer B may use the services of Router R. Thus, there is a line between Router R and Computers A and B, respectively.

Different tools may monitor respective different topological layers. For example, the application layer 140-4 may be monitored using a tool, such as CA APM, to specify what components and services form user-facing applications, where are those components and services are currently running, and how transactions flow between them.

The Infrastructure layer 140-3, which may be monitored by CA UIM, specifies how virtual servers and containers (“dockers”) are hosted on physical servers. The storage layer 140-2, which may be monitored by CA UIM, specifies what storage hierarchies are available to the computing devices. The network layer 140-1, which may be monitored by CA Spectrum and/or CA PM, specifies how the devices are interconnected on a network, and how transactions flow between them.

Each layer may include multiple “fragments” which are groups of connected elements that are isolated from other fragments. According to some embodiments, the topology fragments in each layer may be stitched together to form a unified view of the entire topology of the IT infrastructure.

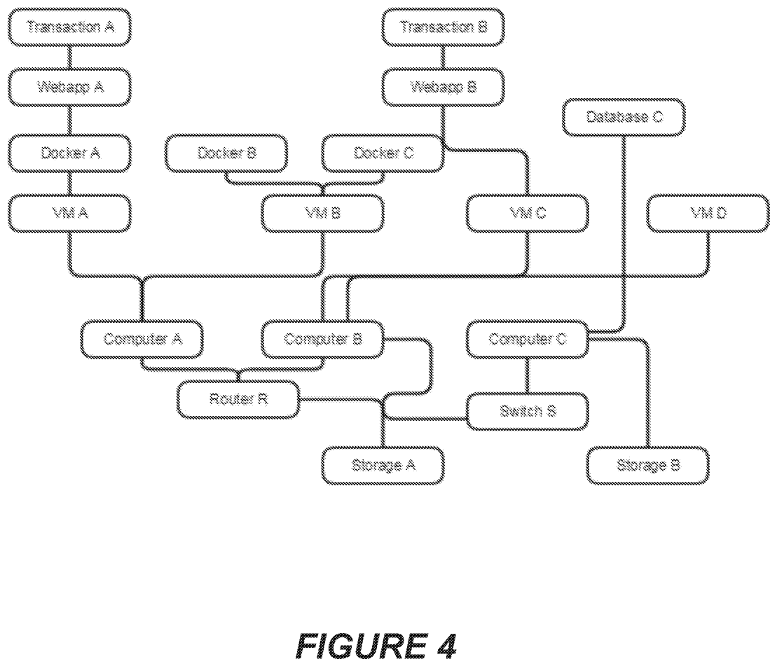

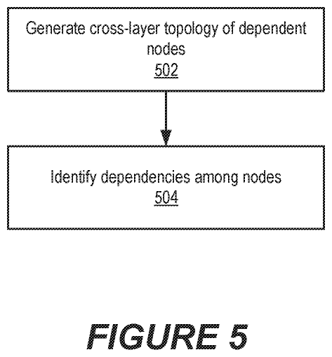

To process alarm messages more efficiently, some embodiments perform topological stitching to assemble the network elements into a single layer. A resulting cross-layer topology is illustrated in FIG. 4. In the topology illustrated in FIG. 4, all layer boundaries are removed. Lines between the elements of the topology indicated functional and/or logical dependency relationships between elements. Operations for creating a cross-layer topology are illustrated in FIG. 5. As shown therein, the operations generate a cross-layer topology of dependent nodes (block 502), for example, by stitching layers into a single topology, and then identify dependencies among the nodes (block 504). These operations are described in more detail below.

The process of layer stitching is based on rules that govern how devices that are represented in different layers correlate to one another such as, for example, rules that specify how to identify duplicate devices across layers when the same device is monitored by different applications. Based on these rules, devices may be de-duplicated and correlated across layers. De-duplication may also be performed using rules that identify common properties across devices in the layers. In the illustration shown in FIG. 3, different topology fragments are collected for different layers, and then based on their device name, are stitched together to form, for example, the cross-layer topology shown in FIG. 4.

It will be appreciated, however, that in IM tools such as CA DOI, rules can be based on any properties, not just the device name. For example, to stitch together a transaction to a docker container, the transaction id may be used. Likewise, to link together a computer and a virtual system, the BIOS ID or the MAC address can be used.

Once the layers have been stitched together and elements have been de-duplicated, some embodiments identify dependencies among the elements. In this context, dependency means that a failure of one element affects the operation of another element. Dependency may be one-way (failure of one affects the operation of another, but not vice versa) or two-way (failure of either one affects the operation of the other).

To identify a dependency relationship between two elements, the systems/methods may check to see if there are any metrics or sets of metrics that correlate between them. For example, there may be a dependency relationship between an application and a network device because if the number of users logged in to an application increases, there will be an increase in the resource consumption on the server it is hosted on, and in turn will see a change in the network traffic and storage traffic.

Between each pairs of devices that are connected topologically, systems/methods according to some embodiments attempt to determine if there is any causal relationship between the devices. For each pair of devices that are topologically connected, the systems/methods calculate a Pearson correlation coefficient between each metric pair associated with the respective devices. A Pearson correlation coefficient is the covariance of the two variables divided by the product of their standard deviations. The Pearson correlation coefficient (PCC) is a measure of the linear correlation between two variables X and Y, and is calculated according to the following equation:

$${ρ}_{X , Y} = \frac{cov ( X , Y )}{{σ}_{X} {σ}_{Y}} \qquad [ 1 ]$$

where cov( ) represents covariance, σₓ is the standard deviation of random variable X and σ_{y} is the standard deviation of random variable Y.

A PCC may have a value between +1 and −1, where +1 indicates total positive linear correlation, 0 indicates no linear correlation, and −1 indicates total negative linear correlation. Analysis of the PCC may reveal, for example, that a storage failure in a storage device may be causally related to an application failure in a processing node.

A whitelist of pairs may be used to optimize the calculation, so that metrics that are known not to be correlated are not looked at. A pair of metrics are considered to be highly correlated (or highly inversely-correlated) if the correlation coefficient is less than −0.9 or greater than 0.9. If there are any metric pairs that are highly correlated or highly inversely-correlated, the devices are considered to be in a causal relationship and are considered to be dependent on one another.

The layer hierarchy (Network-Storage-Infrastructure-Application) may be used to assign a directionality to the relationship. For example, a device lower in the hierarchy may be assumed to have a causal effect on a device higher in the hierarchy.

Causal pairs may be strung together into distinct sets using the principle of transitivity. That is, if a causal relationship between elements a and b exists and a causal relationship between elements b and c exists, then a causal relationship between elements a, b and c also exists.

Relationships between various elements in the example network 100 are illustrated as connecting lines in FIG. 4. Thus, for example, the topology shown in FIG. 4 indicates that Database C has a causal relationship with Computer C, Switch S and Storage B. However, it may not have a causal relationship with Storage A.

Some embodiments may optionally perform behavior normality on the elements of the system before identifying causal relationships. For example, for each element, older metrics (e.g., for the last 30 days) may be processed using a kernel density estimation (KDE) algorithm that predicts what will the metric value should be based on past values. The algorithm may generate three predictions with different levels of confidence, and these predicted values may be compared to the current reported value. If the actual value of the metric differs significantly from the predicted value, it may represent an “anomaly” situation that needs to be addressed.

Once a complete topology has been generated with causal dependencies between various elements defined, systems/methods according to some embodiments may use such information to cluster alarm messages and differentiate root cause alarms from downstream alarms that are generated because of the failure that caused the root cause alarm to be generated. Alarms that are likely or suspected to be root cause alarms may be highlighted, and downstream (dependent) alarms may be suppressed for reporting purposes to allow an operator to focus on likely suspected root cause alarms.

Referring briefly again to FIG. 2, when a new alarm message is received by the alarm message processor 102 in the infrastructure monitoring server 50, the alarm message processor may place the alarm into an alarm group 105 based on its relationship to previously received alarm messages. For the first alarm received by the alarm message processor 102, a new group is created, and the alarm message is placed in the new group and designated as the root cause alarm. That is, because it is the first alarm, it is assumed to be a root cause alarm. The root cause alarm message is associated with a network element that generated the root cause alarm or on whose behalf the root cause alarm was generated.

For subsequent alarm messages, the alarm message processor 102 first determines if the device that generated the alarm (or for which the alarm message was generated) is in a dependency chain with the device associated with the root cause alarm. If it is, then the new alarm message may be related to the root cause alarm (e.g. it may have been caused by the event that caused the root cause alarm).

Before the new alarm message is placed in the alarm group associated with the root cause alarm, the systems/methods may determine whether there is a strong affinity of the alert to the alarm group. The affinity of the alarm message to the alarm group may be calculated in one or more of several ways. For example, in some embodiments, if the alarm is within a sliding time window (for example, within five minutes from the latest alarm in the group), then it may be determined to have a “strong affinity” to the group.

If the alarm is on a device not in the dependency chain, or does not have a strong affinity to the group, then it is not placed in the group and instead a new group is created.

In some embodiments, affinity may be determined based on the type of alarm that was received and the relative locations in the topology of the device for which the alarm message was generated and devices for which alarm messages already in the alarm group were generated. That is, for some types of alarm messages, there may be expected downstream failures. For example, a failure of a network switch may be expected to trigger alarm messages in any device that communicates through the switch and any application residing on such device that uses services of the switch. Thus, a communication failure experienced by an application may be considered to have a strong affinity to a group whose root cause alarm was based on a hardware failure in the network switch, even if it is outside the predefined time window.

As a further example, even if the alarm is not within the time window, the alarm may have a strong affinity to the group if there are anomalies on both the “cause” and “effect” end of the causal relationship.

When an alarm message is deemed to have a “strong affinity” with an alarm group, the alarm message may be placed in the group. For a given alarm message, this process may be repeated for each existing alarm group. A new alarm message may be determined to have a strong affinity with multiple alarm groups, and may accordingly be placed into multiple alarm groups.

Each alarm group has an identified root cause alarm, which is typically the earliest alarm for the device that is deepest in the dependency chain.

The alarm group information is then provided to an operator with the root cause alarms highlighted for the operator to address. Once the root cause alarm has been addressed, the systems/methods may determine if the other alarm messages in the alarm group have been resolved. If they have, then the other alarm messages are removed from the alarm group and from any other alarm group they have been placed into. If they have not been resolved, then the dependency chains may be re-analyzed and a new group may be created if necessary.

For example, if after resolution of the root cause alarm, downstream errors are not resolved within a predetermined time period, the remaining the alerts in the alarm group are analyzed again to see which alert in the sequence of events is the likely root cause alarm for the other alarms in the group.

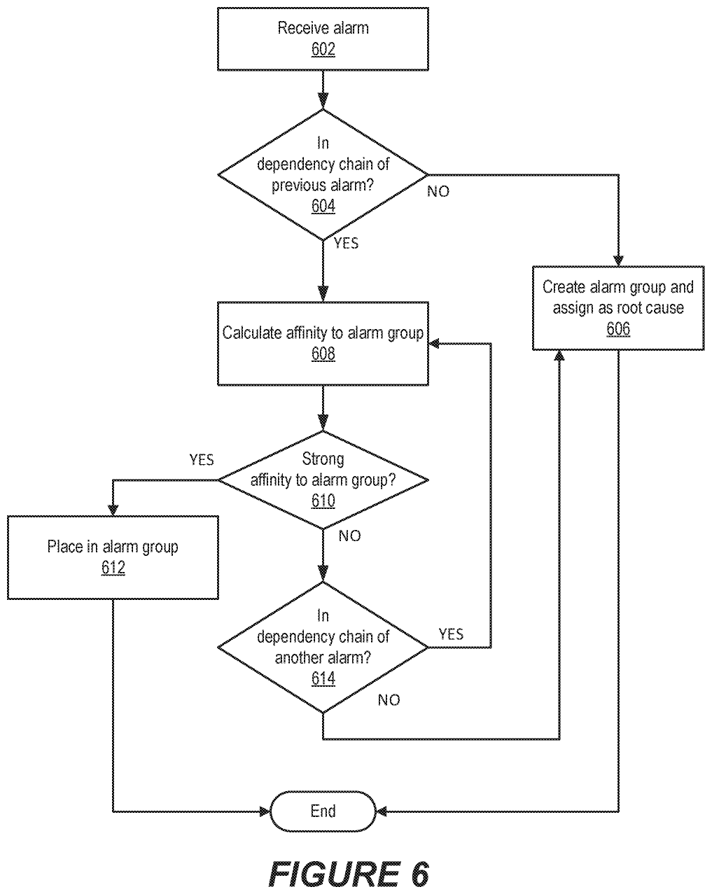

Operations of systems/methods for processing alarm messages in a computer network according to some embodiments are illustrated in the flowchart of FIG. 6. As shown therein, the operations include receiving an alarm message generated by a node in the computer network (block 602). The alarm message indicates a failure in the computer network. The method then determines whether the alarm message falls within a dependency chain of a previous alarm message (block 604). If it does not, then the method creates a new alarm group (block 606), places the alarm message in the new alarm group and designates the message as the root cause alarm in the alarm group. If the method determines that the alarm message falls within the dependency chain of the previous alarm message, the method identifies an alarm group associated with the previous alarm message and determining an affinity of the alarm message to the alarm group (block 608). If there is a strong affinity to the alarm group (block 610), the method adds the alarm message to the alarm group based on the affinity of the alarm message to the alarm group (block 612). If the alarm message does not have a strong affinity to the alarm group, the method checks to see if the alarm message is in a dependency chain of another alarm (block 614), and repeats the process of checking the affinity to the alarm group of the next alarm. If the alarm message does not have a strong affinity to any previous alarm with which it shares a dependency chain, then the methods return to block 606 and a new alarm group is created.

Determining the affinity of the alarm message to the alarm group may include determining a likelihood that the alarm message is related to the root cause alarm. Moreover, the dependency chain of the previous alarm message includes a group of topologically related nodes in the computer network that have failure modes associated with the previous alarm message. Thus, if an alarm message has an affinity to the alarm group, it may be likely that the alarm message is related to a previous failure that affected a node in the dependency chain.

Determining the affinity of the alarm message to the alarm group may include determining whether the alarm message was issued within a predetermined time period from when a last alarm in the alarm group was issued or within a predetermined time period from when the root cause alarm message was issued.

Determining the affinity of the alarm message to the alarm group may include determining whether an alarm type of the alarm message is causally related to an alarm type of the previous alarm. In this regard, types of alarms may be categorized based on the underlying failure and may be causally related to other alarms. For example, a memory failure in a communication switch may be causally related to a link failure for a communication link connected to the switch and a communication failure in a node that utilizes the communication link.

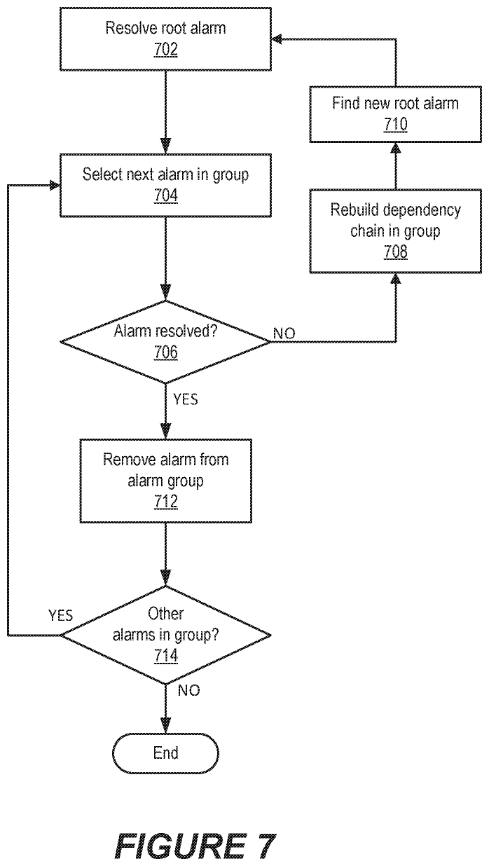

The previous alarm message may be the root cause alarm from which all other alarm messages in the alarm group depend. Referring to FIG. 7, in some embodiments the method includes resolving the root cause alarm (block 702). The method then selects a next alarm message from the alarm group (block 704) and determines whether a failure that caused the alarm message is resolved as a result of resolution of the root cause alarm (block 706). It is possible that when the original root cause alarm is resolved, the dependency relationship among other alarm messages in the alarm group may no longer be valid. Thus, if the failure that caused the alarm message is not resolved as a result of resolution of the root cause alarm, the method rebuilds a dependency chain associated with the alarm group (block 708) and identifies a new root cause alarm associated with the alarm group (block 710). Operations then repeat to resolve the newly identified root cause alarm. If the alarm message is resolved as a result of the resolution of the root cause alarm, then the alarm message is removed from the group. The operations then determine if there are any additional alarm messages left in the group (block 714), and if so, operations return to block 704 to select the next alarm message. Otherwise, operations terminate.

An infrastructure monitoring server for a computer network includes a processor circuit, and a memory coupled to the processor circuit. The memory includes computer readable program instructions that cause the processor circuit to receive an alarm message generated by a node in the computer network, the alarm message indicating a failure in the computer network, determine whether the alarm message falls within a dependency chain of a previous alarm message, in response to determining that the alarm message falls within the dependency chain of the previous alarm message, identify an alarm group associated with the previous alarm message and determining an affinity of the alarm message to the alarm group, and add the alarm to the alarm group based on the affinity of the alarm message to the alarm group.

A method of processing alarm messages in a computer network according to further embodiments is provided, wherein nodes in the computer network are hierarchically arranged in layers including an application layer, an infrastructure layer, a storage layer and a network layer. The method includes generating a cross-layer topology of dependent nodes in the computer network, identifying failure dependencies between nodes in the computer network across layers, receiving a plurality of alarm messages, identifying a root cause alarm from among the plurality of alarm messages, wherein the root cause alarm was generated by a first node in a first layer of the computer network, receiving a new alarm message generated by a second node in a second layer of the computer network that is different than the first layer, wherein the new alarm message indicates a failure in the computer network, determining whether the new alarm message falls within a dependency chain of the root cause alarm, in response to determining that the new alarm message falls within the dependency chain of the root cause alarm, identifying an alarm group associated with the root cause alarm and determining an affinity of the new alarm message to the alarm group, and adding the new alarm message to the alarm group based on the affinity of the new alarm message to the alarm group.

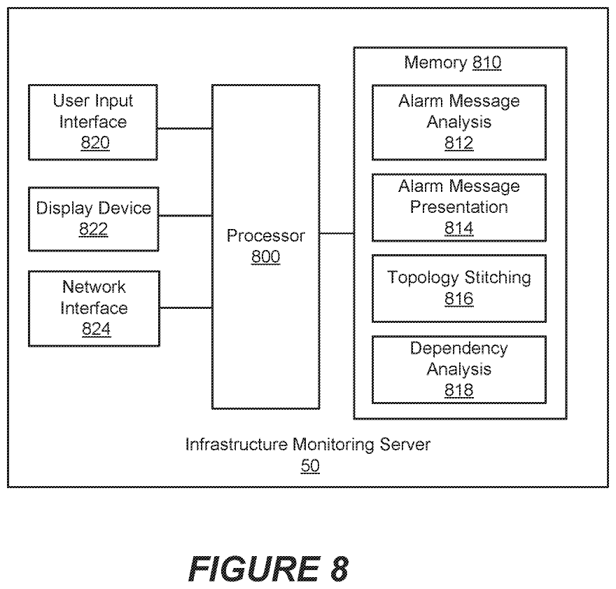

FIG. 8 is a block diagram of a device that can be configured to operate as the infrastructure monitoring server 50 according to some embodiments of the inventive concepts. The infrastructure monitoring server 50 includes a processor 800, a memory 810, and a network interface 824, which may include a radio access transceiver and/or a wired network interface (e.g., Ethernet interface).

The processor 800 may include one or more data processing circuits, such as a general purpose and/or special purpose processor (e.g., microprocessor and/or digital signal processor) that may be collocated or distributed across one or more networks. The processor 800 is configured to execute computer program code in the memory 810, described below as a non-transitory computer readable medium, to perform at least some of the operations described herein. The computer 800 may further include a user input interface 820 (e.g., touch screen, keyboard, keypad, etc.) and a display device 822.

The memory 810 includes computer readable code that configures the infrastructure monitoring server 50 to implement the data collection component 106, the alarm message processor 102, and the infrastructure monitoring function 112. In particular, the memory 810 includes alarm message analysis code 812 that configures the infrastructure monitoring server 50 to analyze and cluster alarm messages according to the methods described above and alarm message presentation code 814 that configures the infrastructure monitoring server to present alarm messages for processing based on the clustering of alarm messages as described above. The memory 810 may further include topology stitching code 816 that generates a cross-layer topology as described above and dependency analysis code 818 that analyzes the cross-layer topology to identify causal dependency relationships between network elements as described above.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method of processing alarm messages in a computer network, comprising:
receiving an alarm message generated by a node in the computer network, the alarm message indicating a failure in the computer network;
determining whether the alarm message falls within a dependency chain of a previous alarm message;
in response to determining that the alarm message falls within the dependency chain of the previous alarm message, identifying an alarm group associated with the previous alarm message and determining an affinity of the alarm message to the alarm group; and
adding the alarm message to the alarm group based on the affinity of the alarm message to the alarm group.

2. The method of claim 1, further comprising, in response to determining that the alarm message does not fall within the dependency chain of the previous alarm message, creating a new alarm group and adding the alarm message to the new alarm group as a root cause alarm of the new alarm group.

3. The method of claim 1, wherein the alarm group comprises a root cause alarm, wherein determining the affinity of the alarm message to the alarm group comprises determining a likelihood that the alarm message was generated as a result of a root failure that caused the root cause alarm to be generated.

4. The method of claim 1, wherein the dependency chain of the previous alarm message comprises a group of topologically related nodes in the computer network.

5. The method of claim 4, wherein the topologically related nodes have failure modes associated with the previous alarm message.

6. The method of claim 1, wherein determining the affinity of the alarm message to the alarm group comprises determining whether the alarm message was issued within a predetermined time period from when a last alarm in the alarm group was issued.

7. The method of claim 1, wherein determining the affinity of the alarm message to the alarm group comprises determining whether the alarm message was issued within a predetermined time period from when the previous alarm message was issued.

8. The method of claim 1, further comprising:
after adding the alarm message to the alarm group, determining whether the alarm message falls within the dependency chain of a further alarm message;
in response to determining that the alarm message falls within the dependency chain of the further alarm message, identifying a further alarm group associated with the further alarm message and determining an affinity of the alarm message to the further alarm group; and
adding the alarm to the further alarm group based on the affinity of the alarm message to the further alarm group.

9. The method of claim 1, wherein determining the affinity of the alarm message to the alarm group comprises determining whether an alarm type of the alarm message is causally related to an alarm type of the previous alarm.

10. The method of claim 1, wherein nodes in the computer network are hierarchically arranged in layers including an application layer, an infrastructure layer, a storage layer and a network layer, and wherein the alarm message was generated by a first node in a first layer of the computer network and the previous alarm message was generated by a second node in a second layer of the computer network that is different than the first layer.

11. The method of claim 10, further comprising:
generating a cross-layer topology of dependent nodes in the computer network; and
identifying failure dependencies between nodes in the computer network across layers.

12. The method of claim 1, wherein the previous alarm message comprises a root cause alarm from which all other alarm messages in the alarm group depend, the method further comprising:
resolving the root cause alarm;
determining whether a failure that caused the alarm message is resolved as a result of resolution of the root cause alarm; and
in response to determining that the failure that caused the alarm message is not resolved as a result of resolution of the root cause alarm, rebuilding a dependency chain associated with the alarm group and identifying a new root cause alarm associated with the alarm group.

13. An infrastructure monitoring server for a computer network, the network management server comprising:
a processor circuit; and
a memory coupled to the processor circuit and comprising computer readable program instructions that cause the processor circuit to:
receive an alarm message generated by a node in the computer network, the alarm message indicating a failure in the computer network;
determine whether the alarm message falls within a dependency chain of a previous alarm message;
in response to determining that the alarm message falls within the dependency chain of the previous alarm message, identify an alarm group associated with the previous alarm message and determining an affinity of the alarm message to the alarm group; and
add the alarm to the alarm group based on the affinity of the alarm message to the alarm group.

14. The infrastructure monitoring server of claim 13, wherein the computer readable program instructions further cause the processor circuit to:
in response to determining that the alarm message does not fall within the dependency chain of the previous alarm message, create a new alarm group and adding the alarm message to the new alarm group as a root cause alarm of the new alarm group.

15. The infrastructure monitoring server of claim 13, wherein the alarm group comprises a root cause alarm, wherein determining the affinity of the alarm message to the alarm group comprises determining a likelihood that the alarm message was generated as a result of a root failure that caused the root cause alarm to be generated.

16. The infrastructure monitoring server of claim 13, wherein the dependency chain of the previous alarm message comprises a group of topologically related nodes in the computer network that have failure modes associated with the previous alarm message.

17. The infrastructure monitoring server of claim 13, wherein the computer readable program instructions further cause the processor circuit to determine the affinity of the alarm message to the alarm group by determining whether the alarm message was issued within a predetermined time period from when a last alarm in the alarm group was issued.

18. The infrastructure monitoring server of claim 13, wherein nodes in the computer network are hierarchically arranged in layers including at application layer, an infrastructure layer, a storage layer and a network layer, and wherein the alarm message was generated by a first node in a first layer of the computer network and the previous alarm message was generated by a second node in a second layer of the computer network that is different than the first layer.

19. The infrastructure monitoring server of claim 13, wherein the computer readable program instructions further cause the processor circuit to:
generate a cross-layer topology of dependent nodes in the computer network; and
identify failure dependencies between nodes in the computer network across layers.

20. A method of processing alarm messages in a computer network, wherein nodes in the computer network are hierarchically arranged in layers including an application layer, an infrastructure layer, a storage layer and a network layer, the method comprising:
generating a cross-layer topology of dependent nodes in the computer network;
identifying failure dependencies between nodes in the computer network across layers;
receiving a plurality of alarm messages;
identifying a root cause alarm from among the plurality of alarm messages, wherein the root cause alarm was generated by a first node in a first layer of the computer network;
receiving a new alarm message generated by a second node in a second layer of the computer network that is different than the first layer, wherein the new alarm message indicates a failure in the computer network;
determining whether the new alarm message falls within a dependency chain of the root cause alarm;
in response to determining that the new alarm message falls within the dependency chain of the root cause alarm, identifying an alarm group associated with the root cause alarm and determining an affinity of the new alarm message to the alarm group; and
adding the new alarm message to the alarm group based on the affinity of the new alarm message to the alarm group.
